(19) United States
(12) Patent Application Publication
(10) Pub. No.: US 2003/0212592 A1
(43) Pub. Date: Nov. 13, 2003

(54) Internet-based system for gathering and providing contact information and distributing and receiving petitions

(76) Inventor: Adam Murray, Los Angeles, CA (US)

Correspondence Address: Adam Murray, Howrey Simon Arnold & White, Suite 1400, 550 S. Hope St., Los Angeles, CA, 90071, US

(21) Appl. No.: 10/142,079

(22) Filed: May 9, 2002

(51) Int. Cl. G06F 17/60

(52) U.S. Cl. 705/12; 709/217

(57) ABSTRACT

Disclosed is a system that enables: (1) a web site (or other information dissemination system) (“site”) to solicit contact information; (2) a user (“user”) to visit the site and to transmit contact information to a site administrator (“administrator”); (3) the administrator to receive contact information from the user; (4) the administrator to transmit petition(s) to the user; (5) the user to receive the unsigned petition(s); and (6) the user to return the signed petition(s) to the administrator.

### FIELD OF THE INVENTION

This invention relates generally to gathering and providing contact information and to distributing and receiving petitions.

### BACKGROUND OF THE INVENTION

Many political processes require that large numbers of signatures be gathered. Petitions signed by registered voters are frequently required to place an initiative, a proposition or a candidate's name on a ballot. Similarly, signed petitions are frequently required to initiate the process for a recall or referendum. These petitions usually have to adhere to rigorous formatting requirements. In many instances, the time period for gathering signatures is quite short in light of the number of signatures that must be gathered. In California, for example, placing an initiative on the ballot requires gathering 419,260 or 670,816 signatures (depending on the type of initiative) from people registered to vote in California. These signatures must be gathered in a single five-month period.

One problem commonly encountered by those wishing to initiate political processes that require large numbers of signatures is exorbitant costs. The gathering of signatures almost always requires large expenditures of money for the dissemination of signature-gathering information, the hiring of paid signature gatherers, and other expenses related to the gathering of large quantities of signatures. A number of years ago, a political consulting firm ran ads in which it agreed to qualify any initiative for the California ballot, in exchange for the payment of $1 million.

Another problem commonly encountered by those seeking to gather large numbers of signatures is the limited time frame in which signatures must be gathered. As noted above, the time period for gathering signatures is frequently quite short in light of the number of signatures that must be gathered.

A further problem that is commonly encountered by those seeking to gather large numbers of signatures is identifying enough signatories or signature gatherers in a given geographic area. This geographic identification process is crucial because so many petitions have geographic limitations. For example, individuals who sign a petition seeking to recall a mayor in a given city probably have to live within that city.

Similarly, signature gatherers commonly find it extremely expensive and time-consuming to identify signatories and signature gatherers who are interested in the topic of a particular petition.

### SUMMARY OF THE INVENTION

The present invention is intended to address these and other problems. One object of the present invention is to decrease the costs of disseminating petitions and signature-gathering information to potential gatherers of signatures. Another object of the present invention is to decrease the time it takes to gather any given number of signatures. A further object of the present invention is to facilitate the identification of signatories and signature gatherers in particular geographic areas. Similarly, still another, object of the present invention is to facilitate the identification of signatories and signature gatherers who are interested in the topic of a particular petition.

In one aspect, the present invention provides a method of distributing petitions. According to the method, a user's contact information, submitted from a remote user computer across a computer network, is received. The user's contact information is stored as a unique entry in a database. At least one petition is transmitted to the user, the at least one petition having a section configured to receive signatures.

In another aspect, the present invention provides a method of receiving petitions. According to the method, contact information is submitted to a remote computer site on a computer network. The site is administered by a petition service. At least one petition is received from the petition service, the at least one petition having a section configured to receive signatures.

In yet another aspect, the present invention provides a system for distributing petitions and gathering signatures, comprising a server on a computer network and a database. The server is configured to receive users' contact information submitted from remote user computers across the computer network. The server is also configured to store the users' contact information in the database. The server is further configured to transmit petitions to one or more of the remote user computers across the computer network. The database is configured to store the users' contact information.

For purposes of summarizing the invention and the advantages achieved over the prior art, certain objects and advantages of the invention have been described above and as further described below. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

All of these embodiments are intended to be within the scope of the invention herein disclosed. These and other embodiments of the present invention will become readily apparent to those skilled in the art from the following detailed description of the preferred embodiments having reference to the attached figures, the invention not being limited to any particular preferred embodiments() disclosed.

### BRIEF DESCRIPTION OF THE DRAWINGS

These and other features and advantages of the invention will now be described with reference to the drawings of certain preferred embodiments, which are intended to illustrate and not to limit the invention, and in which:

FIG. 1 is a high-level flow diagram illustrating the primary steps of a system that operates in accordance with the present invention.

FIG. 2 is an architectural drawing and flow diagram illustrating the primary components of a system that operates in accordance with the present invention.

FIG. 3 is a screen display further illustrating the enrollment function.

### DETAILED DESCRIPTION OF A PREFERRED EMBODIMENT

The present invention provides a method for gathering or providing contact information and distributing or receiving petitions. A Web site administrator (“administrator”) sets up a Web site or other information dissemination system (“site”). The site is configured such that it includes at least one way for someone who visits the site (“user”) to transmit contact information to the administrator. The site could be configured to allow the transmission of contact information in many different ways, for example transmission via a form on a web page of the site or transmission by email.

The user can visit the site and transmit contact information (and perhaps other information) to the administrator. For example, the user may fill out a form on the site that contains fields for an email address, a street address, and/or a phone number. Alternatively, the user may send an email with such information to the administrator.

The administrator can receive the user's contact information and store the information in a database.

The administrator uses the contact information provided by the user to transmit a petition to the user. For example, the administrator may send a petition attached to an email or the administrator may send the petition by regular U.S. mail. Alternatively, an administrator may send an email that contains a link to a Web site where the user could download the petition.

The user receives the petition from the administrator, prints a hard copy version of the petition, and signs the petition and/or has others sign the petition.

In another embodiment of the invention, the user returns the signed petition to the administrator (or to a place designated by the administrator).

Advantageously, aspects of the present invention allow signatures to be gathered very quickly and at very low cost. In addition, once a database of contact information has been established, aspects of the invention allow for the process of petition dissemination and signature gathering to be targeted to a subset of the users and allow the process to be repeated an unlimited number of times.

To facilitate a complete understanding of the invention, the description of the preferred embodiment is arranged within the following sections:

1. GLOSSARY OF TERMS AND ACRONYMS

2. OVERVIEW OF SYSTEM COMPONENTS AND OPERATION

3. CONCLUSION

1. Glossary of Terms and Acronyms

The following terms and acronyms are used throughout the detailed description:

Client-Server. A model of interaction in a distributed system in which a program at one site sends a request to a program at another site and waits for a response. The requesting program is called the “client,” and the program that responds to the request is called the “server.” In the context of the World Wide Web (discussed below), which runs on a computer of a user, the program that responds to browser requests by serving Web pages is commonly referred to as a “Web server.”

Hypertext System. A navigational link from one document to another, or from one portion (or component) of a document to another. Typically, a hyperlink is displayed as a highlighted word or phrase that can be selected by clicking on it using a mouse to jump to the associated document or documented portion.

Internet. A collection of interconnected (public and/or private) networks that are linked together by hyperlinks to form a user navigable “web.”

World Wide Web (“Web”). Used herein to refer generally to both (i) a distributed collection of interlinked, user-viewable hypertext documents (commonly referred to as Web documents or Web pages) that are accessible via the Internet, and (ii) the client and server software components which provide user access to such documents using standardized Internet protocols. Currently, the primary standard protocol for allowing applications to locate and acquire Web documents is HTTP, and the Web pages are encoded using HTML. However, the terms “Web” and “World Wide Web” are intended to encompass future markup languages and transport protocols that may be used in place of (or in addition to) HTML and HTTP.

Web Site. A computer system that serves informational content or a network using the standard protocols of the World Wide Web. Typically, a Web site corresponds to a particular Internet domain name, such as “californiaprogressive.com,” and includes the content associated with a particular organization. As used herein, the term is generally intended to encompass both (i) the hardware/software server components that serve the informational content over the network and (ii) the “back end” hardware/software components that interact with the server components to perform services for Web site users.

HTML (Hyper Text Markup Language). A standard coding convention and set of codes for attaching presentation and linking attributes to informational content within documents. During a document authoring stage, the HTML codes (referred to as “tags”) are embedded within the informational content of the document. When the Web document (or HTML document) is subsequently transferred from a Web server to the browser, the codes are interpreted by the browser and used to parse and display the document. For more information on HTML, see Ian S. Graham, The HTML Source Book, John Wiley and Sons, Inc., 1995 (ISBN 0471-11894-4).

HTTP (HyperText Transfer Protocol). The standard World Wide Web client-server protocol used for the exchange of information (such as HTML documents, and client requests for such documents) between a browser and a Web server. HTTP includes a number of different types of messages which can be sent form the client to the server to request different types of server actions. For example, a “GET” message, which has the format GET<URL>, causes the server to return the document or file located at the specified URL.

URL (Uniform Resource Locator). A unique address which fully specifies the location of a file or other resource on the Internet. The general format of a URL is protocol://machine address:port/path/filename. The port specification is optional, and if none is entered by the user, the browser default to the standard port for whatever service is specified as the protocol.

PUSH Technology. An information dissemination technology used to send data to users over a network. In contrast to the World Wide Web (a “pull” technology), in which the user's browser must request a Web page before it is sent, PUSH protocols send the informational content to the user's computer automatically, typically based on information prespecified by the user.

Petition. A written document that contains a request that some action be taken, and that contains space for signatures to be affixed to the document. A petition can be in electronic or hard copy form.

2. Overview of System Components and Operation

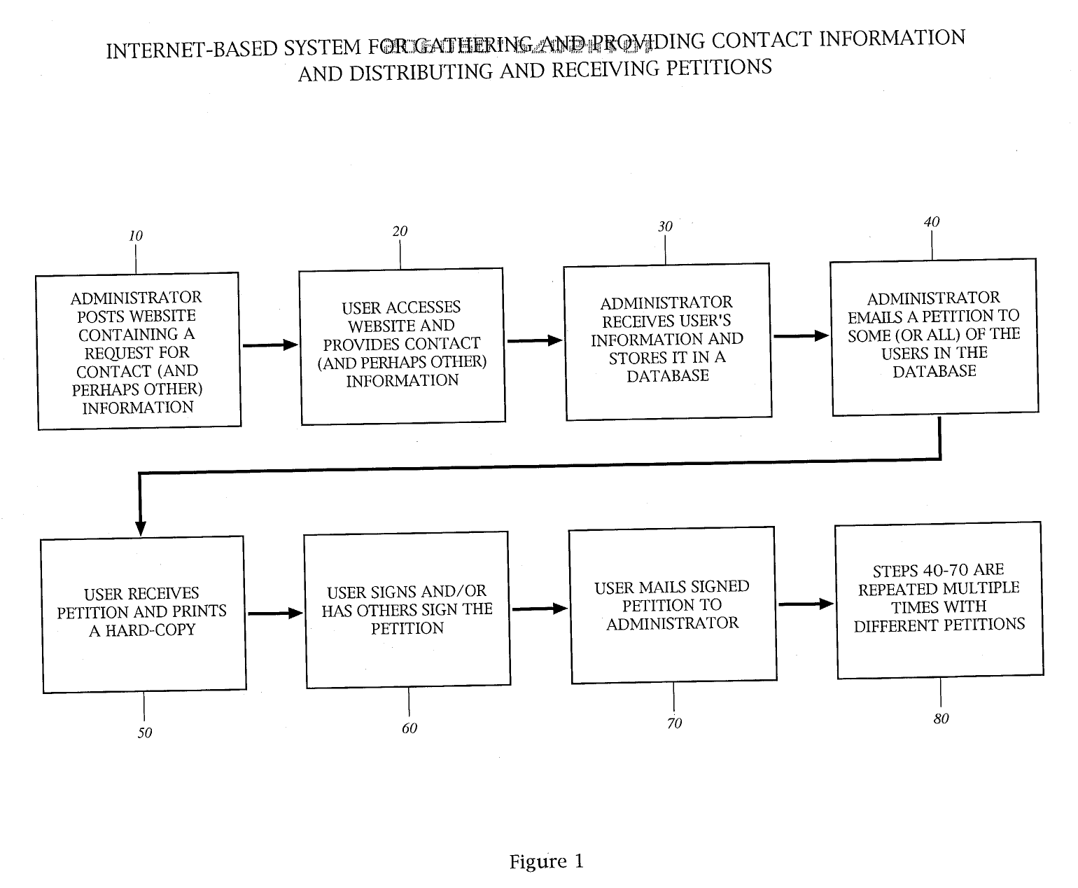

FIG. 1 is a high-level flow diagram illustrating the primary steps of a method of gathering and providing contact information and distributing and receiving petitions, in accordance with a preferred embodiment of the present invention. In the preferred embodiment of the invention illustrated in FIG. 1, the first step is the posting of a Web site by the administrator 10. In this embodiment, one page of the Web site contains a form that requests contact (and perhaps other) information from those who visit the Web page. In the second step of the preferred embodiment, a user accesses the Web site and provides contact (and perhaps other) information 20. In the third step of the preferred embodiment, the administrator receives the user's information and stores it in a database 30. In the fourth step of the preferred embodiment, the administrator emails a petition to some (or all) of the users in its database 40. The skilled artisan will understand that the petition can be delivered to the user in any of a variety of ways, such as by sending an email with a hyperlink to a web page from which the user can download the petition. In the fifth step of the preferred embodiment, the user receives the petition and prints a hard copy of it 50. In the sixth step of the preferred embodiment, the user signs and/or has others sign the petition 60. In the seventh step of the preferred embodiment, the user then sends the signed petition back to the administrator 70. In the eighth step of the preferred embodiment, steps four, five, six and seven are repeated multiple times with additional petitions 80. The skilled artisan will understand that the eighth step is not necessary.

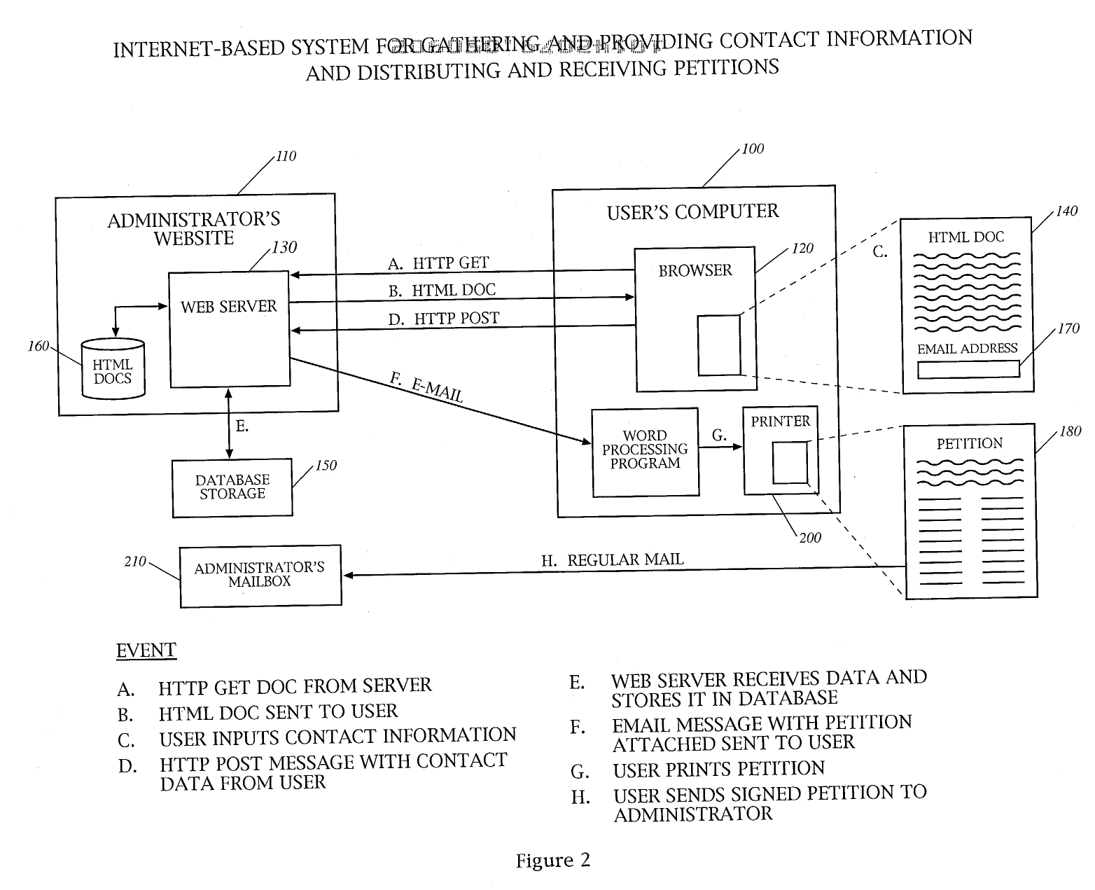

FIG. 2 illustrates the architecture of a system that operates in accordance with the present invention.

The system includes a user's computer 100 and an administrator's Web site 110, which are linked together by the Internet. The user's computer 100 may be any type of computing device that allows the user to interactively browse Web sites via a Web browser 120. For example, the user's computer 100 may be a personal computer (PC) that runs the Windows NT operating system.

In operation, the user' accesses the administrator's Web site 110 using a standard Web browser 120 such as Microsoft's Internet Explorer or Netscape's Navigator, which use the HTTP protocol to communicate with the administrator's Web server 130.

The administrator's Web site 110 will typically be operated by an individual or by a business or non-profit organization. The site may be used solely for the purpose of gathering contact information and disseminating petitions, or it may be used for more general purposes. In an implementation described below, the administrator's Web site 110 has a URL of CaliforniaProgressive.com.

As described below, the site 110 includes software that implements an online registration process for allowing a user (individual, organization etc.) to register contact information 140 (and perhaps other information). A user registering contact information provides the administrator's Web site 110 with a completed, online registration 140 that is processed by a software program at the site. The software creates an entry in the administrator's database 150 according to the information provided by the user.

FIG. 2 also illustrates the general flow of information between the primary components of a system that operates in accordance with the present invention.

The user's computer 100 includes a conventional Web browser 120 that communicates with the administrator's server 130 using the HTTP protocol. The Web server 130 accesses a local store 160 of HTML documents (Web pages) that can be requested, retrieved and viewed by the user via the Web browser 120. These documents may, for example, include information about future petitions, signature gathering drives, or other political news. Access to the administrator's Web site 130 and the registration function is available to any user computer 100 that has access to the Web.

As further illustrated in FIG. 2, the enrolling user begins the enrollment function by selecting the proper hyperlink from the administrator's Web page containing online registration instructions. The administrator's Web server 130 accesses a local store of HTML documents 160 and returns an online registration application document 140 to the enrolling user's Web browser 120. The enrolling user can then fill out the online registration form 140.

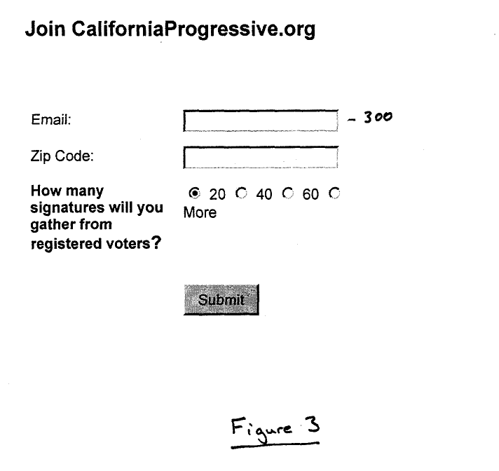

Referring to FIG. 3, a preferred embodiment of the online registration form 140 is shown. The registration form requests information about the user, including the email address of the user 300. In addition, the registration form may request additional information about the user, for example it may request the user's address and it may solicit information about the sorts of petitions in which the user might be interested. Many alternative formats to the online application form are possible and FIG. 3 is only representative of some of the types of information that may be requested.

With further reference to FIG. 2, once the electronic registration form 140 is completed by the user, it is sent from the user's computer 100 to the administrator's Web server 130 for further processing. As will be appreciated by those skilled in the art, other forms of registration processing may be used, including but not limited to regular mail and electronic mail. In addition, although the automated registration function is preferably handled by the same computer system that posts the Web page, these functions could be performed by dedicated, physically distinct computer systems or sites.

In response to submission of the registration form 140, the administrator's Web server 130 initiates a computer program comprising registration software that processes the information contained on the electronic registration form 140. In one implementation, the software scans the registration text for pre-specified terms, and to flag the registration for further review (such as by a staff member) if such a term exists. If no such term is found, and the registration is complete, the registration software automatically accepts the registration.

As part of this online registration, once the registration has been processed (either automatically or with human intervention), the registration software stores the information provided by the registering user as a unique entry in a user database 150. The database may be any type of data repository including, for example, an SQL table or ASCII text file. This database entry allows the administrator Web site to transmit materials to the user as further described below.

In one implementation of the invention, the administrator's Web site automatically formats and transmits an electronic mail message to the email address 170 of the registered user. This electronic mail message provides detailed information about a particular petition. In addition, a petition 180 may be attached to the email. The petition 180 may be sent as any type of electronic file including, for example, a Word Document or Adobe File.

In an alternative implementation, the database of users 150 may be automatically or manually sorted and an electronic mail message sent to the email addresses of a subset of the registered users. The database 150 may be sorted in numerous different ways. For example, if the petition involves a recall campaign in San Diego County, the database may be sorted so that petitions 180 are only emailed to users who live in San Diego County. Similarly, the database 150 may be sorted so that petitions 180 are emailed to those users who are most likely to be interested in the topic of a particular petition.

The administrator's transmission of electronic mail messages to a user (with or without petitions attached) may be repeated multiple times over the course of many years. The multiple messages may relate to the same petition, or they may relate to unrelated petitions. For example, a user may receive one or more new petitions every election cycle.

In one implementation of the invention, upon receipt of the electronic mail message on their computer 100, a user would create a hard copy version of the petition 180 by sending the attached document to their printer 200. The user may print one or more copies of the petition 180. In addition, the user may photocopy (or otherwise reproduce) multiple copies of the petition 180.

The user may alter the petition 180 before or after printing it. For example, the user may adjust the formatting of the electronic document so that it prints-more cleanly. Or, the user may adjust the text of the petition 180 to reflect, for example, the location (state, county, city, etc.) in which signatures are being gathered.

After obtaining a hard copy of the petition 180 the user signs the petition and/or has others sign the petition 180. The user then transmits the hard copy of the signed petition to the administrator (or to a place designated by the administrator) 210. The signed petition could be transmitted by any means that delivers the petition to the administrator (or to a place designated by the administrator) 210. For example, the user might transmit the petition by U.S. Mail, Fed Ex or hand delivery.

At present, most government agencies only accept original, non-electronic signatures. If an electronic reproduction of a signature is permitted in a given jurisdiction, the user may transmit an electronic replication of the signed petition by any means of electronic communication, for example, by facsimile or email.

If an electronic signature is permitted in a given jurisdiction, the user may transmit electronic signatures by any means of electronic communication. For electronic signatures, a user may open the attached petition, electronically sign it (and/or have others electronically sign it) and return it to the administrator (or to a place designated by the administrator) without ever printing a hard copy of the petition.

3. Conclusion

While the invention has been described herein with reference to certain preferred embodiments, these embodiments have been presented by way of example only, and not to limit the scope of the invention. Many other variations are possible. Accordingly, the scope of the invention should be defined only in accordance with the claims that follow.

In the following claims, the order in which claim steps are presented is not necessarily intended to imply any particular order for performing the steps.

What is claimed is:

1. A method of distributing petitions, comprising:
receiving a user's contact information submitted from a remote user computer across a computer network;
storing the user's contact information as a unique entry in a database; and
transmitting at least one petition to the user, the at least one petition having a section configured to receive signatures.

2. The method of claim 1, wherein the user's contact information is received by a computer site on the computer network, the user computer being remote with respect to the computer site.

3. The method of claim 2, wherein the computer site comprises a Web site.

4. The method of claim 1, wherein the computer network comprises the World Wide Web.

5. The method of claim 1, further comprising receiving at least one petition from the remote user, the received at least one petition including signatures within said section.

6. The method of claim 5, further comprising receiving the at least one petition electronically across the computer network from the remote user computer.

7. The method of claim 1, wherein transmitting at least one petition to the user comprises transmitting at least one petition to the remote user computer across the computer network.

8. The method of claim 1, wherein transmitting at least one petition to the user comprises sending an email message to the user, the email message including a hyperlink to a site on the computer network from which the user can download the at least one petition.

9. The method of claim 1, wherein transmitting at least one petition to the user comprises sending an email message to the user, the email message including an attached petition.

10. The method of claim 1, wherein the user's contact information comprises an email address.

11. The method of claim 1, wherein the database includes contact information of a plurality of users, the method further comprising transmitting petitions to a subset of said plurality of users.

12. The method of claim 1, further comprising receiving information regarding the user's areas of interest.

13. The method of claim 12, further comprising sorting through said information regarding the user's areas of interest to determine appropriate petitions to send to the user.

14. A method of receiving petitions, comprising:
submitting contact information to a remote computer site on a computer network, the site being administered by a petition service; and
receiving at least one petition from the petition service, the at least one petition having a section configured to receive signatures.

15. The method of claim 14, wherein submitting contact information to the computer site comprises submitting an email address.

16. The method of claim 14, wherein receiving at least one petition from the petition service comprises receiving the at least one petition electronically across the computer network from the remote computer site.

17. The method of claim 14, further comprising transmitting the at least one petition to the petition service, the at least one petition including signatures within said section.

18. The method of claim 17, wherein the at least one petition is transmitted to the petition service electronically.

19. The method of claim 17, wherein transmitting the at least one petition to the petition service comprises non-electronically delivering the at least one petition to a physical location.

20. A system for distributing petitions and gathering signatures, comprising:
a server on a computer network, the server configured to receive users' contact information submitted from remote user computers across the computer network, the server configured to store said users' contact information in a database, the server configured to transmit petitions to one or more of said remote user computers across the computer network; and
a database configured to store said users' contact information.

21. The system of claim 20, wherein the database is local with respect to the server.

22. The system of claim 20, wherein the server is configured to send email messages to the remote user computers across the computer network, the petitions comprising computer files attached to said email messages.

23. The system of claim 20, wherein the server is configured to send email messages to the remote user computers across the computer network, the email messages including a hyperlink to a site on the computer network from which the user can download the at least one petition.

24. The system of claim 20, wherein the computer network comprises the World Wide Web, and server comprising a Web server.

25. The system of claim 20, wherein the Web server is configured to transmit HTML documents to the remote user computers, the HTML documents including Web forms having information fields configured to receive the users' contact information.
